(19) United States
(12) Patent Application Publication
(10) Pub. No.: US 2014/0043258 A1
(43) Pub. Date: Feb. 13, 2014

(54) Tablet Touch Display Device and Control Method

(71) Applicant: WISTRON CORPORATION, New Taipei City (TW)

(72) Inventors: TAO XU, New Taipei City (TW); XINHONG KANG, New Taipei City (TW); NA DONG, New Taipei City (TW)

(73) Assignee: Wistron Corporation, New Taipei City (TW)

(21) Appl. No.: 13/893,365

(22) Filed: May 14, 2013

(30) Foreign Application Priority Data
Aug. 10, 2012 (CN) 201210285661.4

(51) Int. Cl. G06F 3/041

(52) U.S. Cl. CPC G06F 3/0412
USPC 345/173

(57) ABSTRACT

A tablet touch display device is disclosed. The tablet touch display device includes a switch for generating a first control signal and a second control signal and comprising a slide slid by an external force to adjust the first control signal and the second control signal, a touch device for outputting a touch signal such that the tablet touch display device executes a touch function, an accelerometer for outputting a rotate signal such that the tablet touch display device executes a screen rotation function, a control module coupled to the switch, the touch device and the accelerometer for outputting a display signal according to the first control signal, the second control signal, the touch signal and the rotate signal, and a display coupled to the control module for displaying a screen associated with the touch function and the screen rotation function according to the display signal.

### BACKGROUND OF THE INVENTION

1. Field of the Invention

The present invention relates to a tablet touch display device and control method, and more particularly, to a tablet touch display device and control method capable of controlling a rotate function and a touch function of a screen by a hardware switch.

2. Description of the Prior Art

A touch display device provides intuitional and easy operations and has been widely utilized among electrical products. However, sometimes misoperations may happen when using the touch function, which may cause a working program being shut down or exited. For example, an editing document could be closed and lost due to some wrong touches by the editor or someone else. Or, a working program or a playing video could be closed and lost due to some misoperations and it may take time or effort to regain the lost program or the lost video.

On the other hand, in order to achieve more lively interactions with users, a portable touch display device, e.g. a tablet PC, may further include an Accelerometer or a Gyroscope to sense a horizontal/vertical moving direction or a rotating direction of the tablet PC to change a display direction of its screen. However, in some particular occasion, such as a market place or an exhibition center, the screen is preferably fixed rather than rotating since the rotating screen may not be seen clearly by the audience and degenerate a purpose of demonstration.

Besides, traditionally, the touch function and the screen rotation function are controlled by corresponding software programs, which means the user has to find a software program for the touch function and a software program for the screen rotation function to respectively turn on or off the touch function and the screen rotation function, which is inconvenient for the users not familiar with utilizing software programs.

Therefore, how to provide an easier operation to respectively control the touch function and the screen rotation function of the touch display and prevent misoperations has become a topic of the industry.

### SUMMARY OF THE INVENTION

It is therefore an object of the present invention to provide a tablet touch display device and control method to turn on or off a rotate function and a touch function of a screen by a hardware switch.

The present invention discloses a tablet touch display device, comprising a switch for generating a first control signal and a second control signal and comprising a slide slid by an external force to adjust the first control signal and the second control signal, a touch device for outputting a touch signal such that the tablet touch display device executes a touch function, an accelerometer for outputting a rotate signal such that the tablet touch display device executes a screen rotation function, a control module coupled to the switch, the touch device and the accelerometer for outputting a display signal according to the first control signal, the second control signal, the touch signal and the rotate signal, and a display coupled to the control module for displaying a screen associated with the touch function and the screen rotation function according to the display signal.

The present invention further discloses a control method for a tablet touch display device, wherein a switch of the tablet touch display device comprises a slide slid by an external force, the control method comprising generating a first control signal and a second control signal by the switch and adjusting the first control signal and the second control signal according to a position of the slide, and determining whether to execute a touch function according to the first control signal and determining whether to execute a screen rotation function according to the second control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a tablet touch display device according to an embodiment of the present invention.

FIG. 2 is a functional block diagram of the tablet touch display device shown in FIG. 1.

FIG. 3 is a structure diagram of a two-way sliding switch.

FIG. 4 is a structure diagram of a one-way sliding switch.

FIG. 5 is a schematic diagram of a control process according to an embodiment of the present invention.

### DETAILED DESCRIPTION

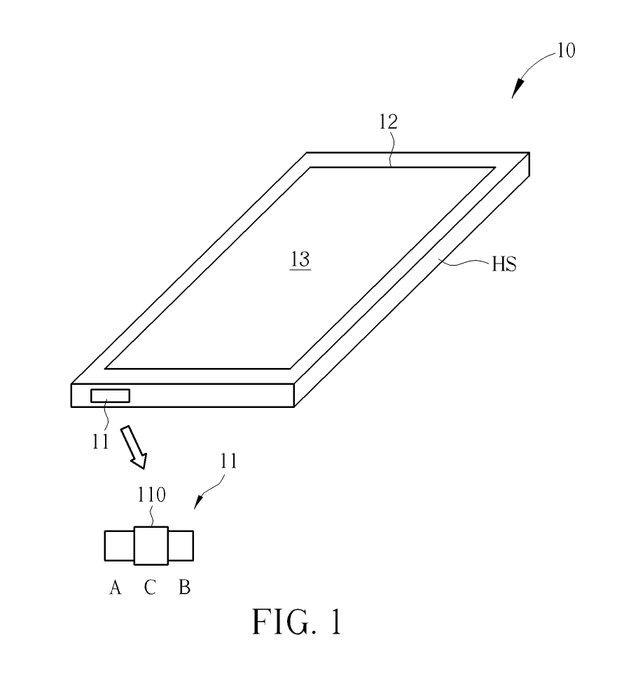

Please refer to FIG. 1, which is a schematic diagram of a tablet touch display device 10 according to an embodiment of the present invention. The tablet touch display device 10 may be a portable touch display device such as a Tablet PC, a smart phone, a Personal Digital Assistant, an E-Album and so on. As shown in FIG. 1, the tablet touch display device 10 includes a touch device 12, a display 13, a housing HS and a switch 11. The switch 11 may be disposed on a side surface of the housing HS. The switch 11 includes a slide 110, a user may slide the slide 110 to left or right to switch a position of the slide 110 so as to respectively turn on or off a touch function and a screen rotation function of the tablet touch display device 10. For example, if the user slides the slide 110 to a position A, the touch function of the touch device 12 may be turned off or locked, while the screen rotation function is kept working. If the user slides the slide 110 to a position B, the screen rotation function of the display 13 may be turned off or locked, while the touch function is kept working. If the user slides the slide 110 to a position C, the touch function and the screen rotation function are both kept working. In short, the user may easily switch the touch function and the screen rotation function of the tablet touch display device 10 by the hardware switch 11, i.e. only turn on the touch function, only turn on the screen rotation function, or turn on both of the touch function and the screen rotation function.

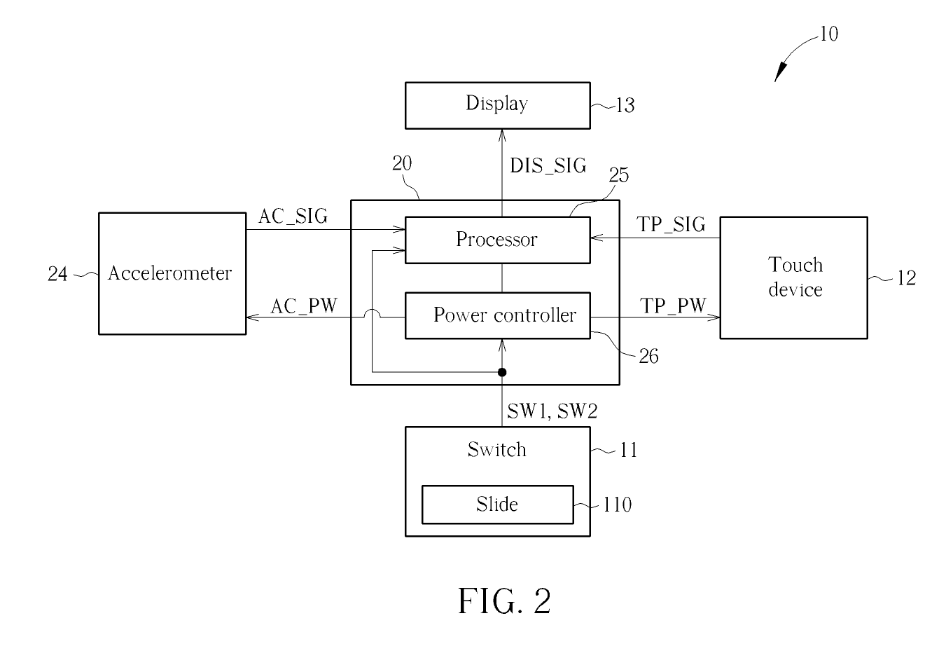

In operation, please refer to FIG. 2, which is a functional block diagram of the tablet touch display device 10 shown in FIG. 1. Except for the switch 11, the touch device 12 and the display 13, the tablet touch display device 10 further includes a control module 20 and an accelerometer 24. Specifically, the switch 11 is used for generating control signals SW1 and SW2, the user may slide the slide 110 to the position A, B or C to adjust the control signals SW1 and SW2, so as to turn on or off the touch function and the screen rotation function. The touch device 12 is coupled to the control module 20 for outputting a touch signal TP_SIG to the control module 20 according to a touch situation of the user, such that the control module 20 may execute relative applications and interactions with the user. The accelerometer 24 is coupled to the control module 20 for detecting a rotating or moving direction of the tablet touch display device 10 to output a rotate signal AC_SIG to the control module 20, such that the control module 20 may execute the screen rotation function. The control module 20 is coupled to the switch 11, the touch device 12, the display 13 and the accelerometer 24 for outputting a display signal DIS_SIG to the display 13 according to the control signals SW1 and SW2, the touch signal TP_SIG and the rotate signal AC_SIG. The display 13 is coupled to the control module 20 for displaying a screen associated with the touch function and the screen rotation function according to the display signal DIS_SIG.

As shown in FIG. 2, the control module 20 includes a processor 25 and a power controller 26. The power controller 26 is coupled to the switch 11, the touch device 12 and the accelerometer 24 for outputting a power signal TP_PW to the touch device 12 according to the control signal SW1 to switch a power of the touch device 12, so as to turn on or off the touch function. Besides, the power controller 26 is used for outputting a power signal AC_PW to the accelerometer 24 according to the control signal SW2 to switch a power of the accelerometer 24, so as to turn on or off the screen rotation function. The processor 25 is coupled to the display 13, the touch device 12 and the accelerometer 24 for outputting the display signal DIS_SIG to the display 13 according to the touch signal TP_SIG and the rotate signal AC_SIG such that the display 13 may display the screen associated with the interactions with the user or display the rotated screen.

Further more, the switch 11 may directly be coupled to the processor 25 to control whether to execute the interactions and applications associated with the touch signal TP_SIG according to the control signal SW1, so as to control the function of the touch device 12. Also, the processor 25 may control whether to execute the function of screen rotation associated with the rotate signal AC_SIG according to the control signal SW2, so as to rotate a display direction of the screen.

In short, the present invention is to dispose the hardware switch 11 on the housing HS of the tablet touch display device 10, such that the user may simply slide the slide 110 of the switch 11 to the positions A, B or C to adjust the control signals SW1 and SW2, such that the power controller 26 may accordingly turn on or off the power of the touch device 12 and the accelerometer 24, to lock the functions of the touch and the screen rotation. Meanwhile, the switch 11 may output the control signals SW1 and SW2 to the processor 25, and the processor 25 may directly control the interactions and applications associated with the touch function and the screen rotation function, which may lock the touch function and the screen rotation function as well.

Please note that present invention is not limited to the above embodiment, those skilled in the art may make modifications and alterations accordingly. For example, the position where the switch 11 is disposed on the tablet touch display device 10 is not limited, the switch 11 may be disposed on any side surface of the housing HS or a top surface, i.e. the surface where the display 13 is located, or a bottom surface of the housing HS according to different appearance requirements.

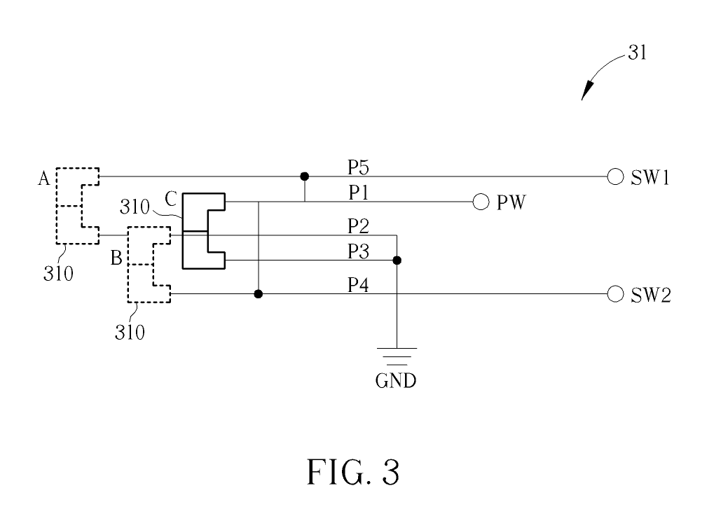

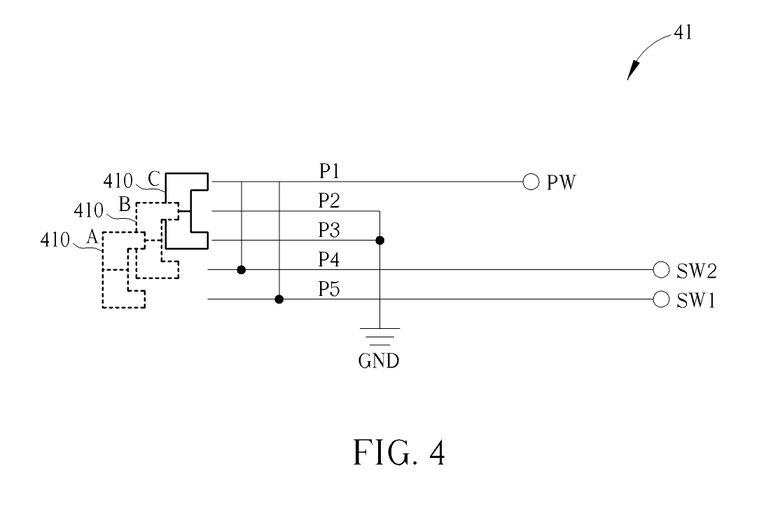

Moreover, the switch 11 may be a one-way sliding switch or a two-way sliding switch. Please refer to FIG. 3 and FIG. 4, FIG. 3 is a structure diagram of the two-way sliding switch 3, FIG. 4 is a structure diagram of the one-way sliding switch 41. As shown in FIG. 3, the two-way sliding switch 31 includes a slide 310 and pins P1-P5, wherein the pin P1 is coupled to a power terminal PW for providing a high logic level, the pins P2 and P3 are coupled to a ground terminal GND for providing a low logic level. The pin P4 is coupled to the pin P1 for outputting the control signal SW2. The pin P5 is coupled to the pin P1 for outputting the control signal SW1.

In such a structure, when the slide 310 is slid to the position A by an external force, i.e. the user slides the slide 310 to the position A, the pin P2 and the pin P5 may be connected by the slide 310 and the control signal SW1 is coupled to the ground terminal GND, so that the control signal SW1 is at the low logic level, such that the power controller 26 is notified to turn off the power of the touch device 12 and lock the touch function. When the slide 310 is slid to the position B by the external force, the pin P2 and the pin P4 may be connected by the slide 310 and the control signal SW2 is coupled to the ground terminal GND, so that the control signal SW2 is at the low logic level, such that the power controller 26 is notified to turn off the power of the accelerometer 24 and lock the screen rotation function. When the slide 310 is slid to the position C by the external force, the pin P4 and the pin P5 are not coupled to the ground terminal GND and the control signals SW1 and SW2 are at the high logic level, such that the power controller 26 may supply the power to the touch device 12 and the accelerometer 24 and the touch function and the screen rotation function are both kept working. As a result, the user may easily adjust the logic level of the control signals SW1 and SW2 by sliding the slide 310 to the position A, B or C to control turning on or off the touch function and the screen rotation function.

As shown in FIG. 4, the one-way sliding switch 41 includes a slide 410 and pins P1-P5. A structure of the one-way sliding switch 41 is similar to a structure of the two-way sliding switch 31 and coupling connections between pins P1-P5 are similar too. A pin order of the pins P1-P5 of the switch 31 is different from a pin order of the switch 41, the pin order of the two-way sliding switch 31 is P5, P1, P2, P3 and P4, and thus a position order sliding the slide 310 is A, C and B. In comparison, the pin order of the one-way sliding switch 41 is P1, P2, P3, P4 and P5, and thus a position order sliding the slide 410 is C, B and A. Operations of the one-way sliding switch 41 may be obtained by referring to the operations of the two-way sliding switch 31, which is omitted herein.

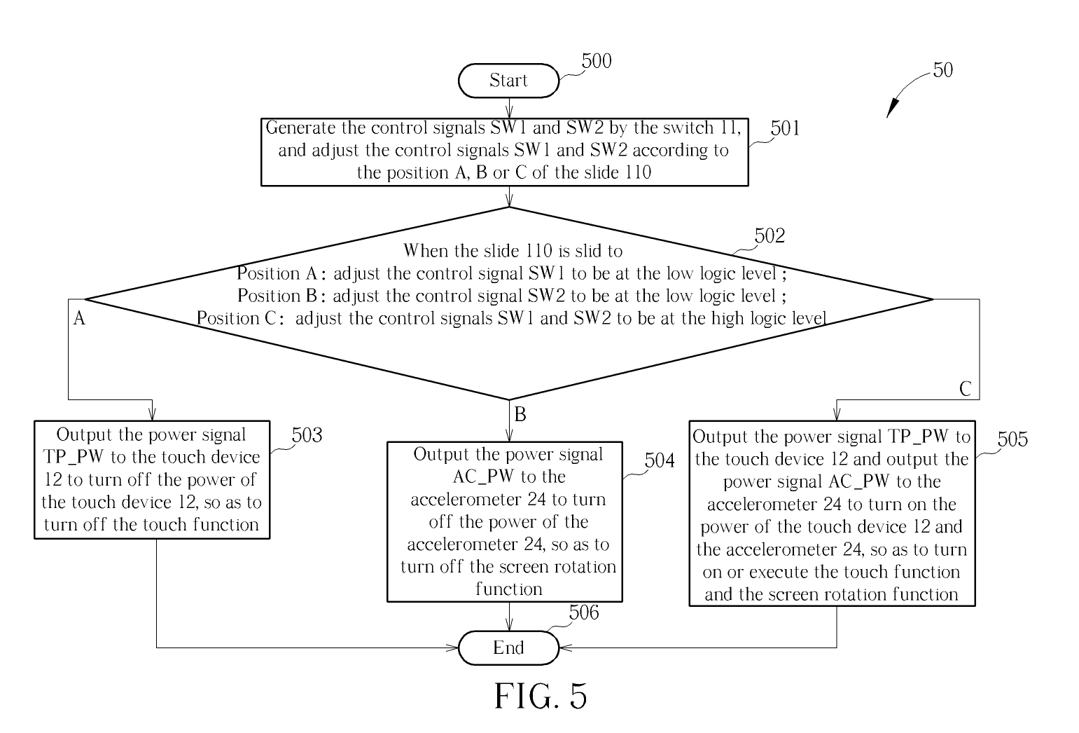

Operations of the tablet touch display device 10 may be summarized into a control process 50. As shown in FIG. 5, the control process 50 includes the following steps:

Step 500: Start.

Step 501: Generate the control signals SW1 and SW2 by the switch 11, and adjust the control signals SW1 and SW2 according to the position A, B or C of the slide 110.

Step 502: When the slide 110 is slid to the position A and the control signal SW1 is at the low logic level, perform Step 503; when the slide 110 is slid to the position B and the control signal SW2 is at the low logic level, perform Step 504; when the slide 110 is slid to the position C and the control signals SW1 and SW2 are at the high logic level, perform Step 505.

Step 503: Output the power signal TP_PW to the touch device 12 to turn off the power of the touch device 12, so as to turn off the touch function.

Step 504: Output the power signal AC_PW to the accelerometer 24 to turn off the power of the accelerometer 24, so as to turn off the screen rotation function.

Step 505: Output the power signal TP_PW to the touch device 12 and output the power signal AC_PW to the accelerometer 24 to turn on the power of the touch device 12 and the accelerometer 24, so as to turn on or execute the touch function and the screen rotation function.

Step 506: End.

Operations of the control process 50 may be obtained by referring to above description, which is omitted herein.

To sum up, while the traditional tablet touch display device may respectively turn on or off the functions of the touch control and the screen rotation by some specific software applications, it is inconvenient for users not familiar with utilizing software programs. In comparison, the present invention disposes the hardware switch on the housing of tablet touch display device, such that the user may simply slide the slide of the switch to directly lock or control the touch function and the screen rotation function to prevent misoperations. As a result, in some particular occasion such the market place and the exhibition center, a staff or provider may easily turn off the touch function and the screen rotation function so that the audience may simply watch rather than operate. Or the staff or provider may turn on the touch function and the screen rotation function so that the audience can operate and interact with the touch display device. Moreover, the present invention may be utilized in education for toddlers and small children since the sliding switch may easily turn off the touch function to avoid misoperations by the small children, and the screen is viewed only. Therefore, the present invention may provide an easier operation to respectively control the touch function and the screen rotation function of the touch display to avoid misoperations and increase a market value of the tablet touch display device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A tablet touch display device, comprising:
a switch for generating a first control signal and a second control signal and comprising a slide slid by an external force to adjust the first control signal and the second control signal;
a touch device for outputting a touch signal such that the tablet touch display device executes a touch function;
an accelerometer for outputting a rotate signal such that the tablet touch display device executes a screen rotation function;
a control module coupled to the switch, the touch device and the accelerometer for outputting a display signal according to the first control signal, the second control signal, the touch signal and the rotate signal; and
a display coupled to the control module for displaying a screen associated with the touch function and the screen rotation function according to the display signal.

2. The tablet touch display device of claim 1, wherein the control module comprises a power controller coupled to the switch, the touch device and the accelerometer for outputting a first power signal to the touch device according to the first control signal to switch a power of the touch device so as to turn on or off the touch function, and outputting a second power signal to the accelerometer according to the second control signal to switch a power of the accelerometer so as to turn on or off the screen rotation function.

3. The tablet touch display device of claim 2, wherein when the slide is slid by the external force such that the first and the second control signal are at a low logic level, the power controller respectively outputs the first and second power signals to the touch device and the accelerometer to turn off the power of the touch device and the accelerometer, so as to turn off the touch function and the screen rotation function; and when the slide is slid by the external force such that the first and second control signals are at a high logic level, the power controller respectively outputs the first and second power signals to the touch device and the accelerometer to turn on the power of the touch device and the accelerometer, so as to turn on the touch function and the screen rotation function.

4. The tablet touch display device of claim 1, wherein the control module further comprises a processor coupled to the power controller, the touch device, the accelerometer and the display for outputting the display signal to the display according to the touch signal and the rotate signal, such that the display displays the screen associated with the touch function and the screen rotation function according to the display signal.

5. The tablet touch display device of claim 4, wherein the processor is further coupled to the switch for determining whether to execute the touch function and the screen rotation function according to the first control signal and the second control signal.

6. The tablet touch display device of claim 5, wherein when the slide is slid by the external force such that the first and second control signals are at a low logic level, the processor stops executing the touch function and the screen rotation function; and when the slide is slid by the external force such that the first and second control signal are at a high logic level, the processor executes the touch function and the screen rotation function.

7. The tablet touch display device of claim 1, wherein the switch further comprises:
a first pin coupled to a power terminal for providing a high logic level;
a second pin coupled to a third pin and a ground terminal for providing a low logic level;
a fourth pin coupled to the first pin for outputting the second control signal; and
a fifth pin coupled to the first pin for outputting the first control signal.

8. The tablet touch display device of claim 7, wherein when the slide is slid by the external force such the second pin and the fifth pin are connected, the first control signal is coupled to the ground terminal and at the low logic level so as to turn off the touch function; when the slide is slid by the external force such the second pin and the fourth pin are connected, the second control signal is coupled to the ground terminal and at the low logic level so as to turn off the screen rotation function; and when the slide is slid by the external force such the fourth pin and the fifth pin are not connected to the ground terminal, the first control signal and the second control signal are at the high logic level so as to execute the touch function and the screen rotation function.

9. The tablet touch display device of claim 7, wherein the switch is a two-way sliding switch or a one-way sliding switch.

10. The tablet touch display device of claim 1, further comprising a housing, the switch is disposed on a side surface, atop surface or a bottom surface of the housing.

11. A control method for a tablet touch display device, wherein a switch of the tablet touch display device comprises a slide slid by an external force, the control method comprising:
generating a first control signal and a second control signal by the switch and adjusting the first control signal and the second control signal according to a position of the slide; and
determining whether to execute a touch function according to the first control signal and determining whether to execute a screen rotation function according to the second control signal.

12. The control method of claim 11, wherein the step of determining whether to execute a touch function according to the first control signal and determining whether to execute a screen rotation function according to the second control signal comprises:
stop executing the touch function and the screen rotation function when the slide is slid by the external force such that the first and second control signals are at a low logic level; and
executing the touch function and the screen rotation function when the slide is slid by the external force such that the first and second control signals are at a high logic level.

13. The control method of claim 11, wherein the step of determining whether to execute a touch function according to the first control signal and determining whether to execute a screen rotation function according to the second control signal comprises:
outputting a first power signal to a touch device to switch a power of the touch device according to the first control signal, so as to turn on or off the touch function; and
outputting a second power signal to an accelerometer to switch a power of the accelerometer according to the second control signal, so as to turn on or off the screen rotation function.

14. The control method of claim 13, wherein when the slide is slid by the external force such that the first and second control signals are at a low logic level, the first and second power signals turn off the power of the touch device and the power of the accelerometer to turn off the touch function the screen rotation function, and when the slide is slid by the external force such that the first and second control signals are at a high logic level, the first and second power signals turn on the power of the touch device and the power of the accelerometer to turn on the touch function and the screen rotation function.

15. The control method of claim 11, wherein the switch further comprises:
a first pin coupled to a power terminal for providing the high logic level;
a second pin coupled to a third pin and a ground terminal for proving the low logic level;
a fourth pin coupled to the first pin for outputting the second control signal; and
a fifth pin coupled to the first pin for outputting the first control signal.

16. The control method of claim 15, wherein when the slide is slid by the external force such that the second pin and the fifth pin are connected, the first control signal is coupled to the ground terminal and the first control signal is at the low logic level, so as to turn off the touch function; when the slide is slid by the external force such that the second pin and the fourth pin are connected, the second control signal is coupled to the ground terminal and the second control signal is at the low logic level, so as to turn off the screen rotation function; and when slide is slid by the external force such that the fourth pin and the fifth pin are not coupled to the ground terminal, the first control signal and the second control signal are at the high logic level, so as to execute the touch function and the screen rotation function.

17. The control method of claim 15, wherein the switch is a two-way sliding switch or a one-way sliding switch.

18. The control method of claim 11, wherein the tablet touch display device further comprising a housing, the switch is disposed on a side surface, a top surface or a bottom surface of the housing.
